(19) United States
(12) Patent Application Publication
(10) Pub. No.: US 2013/0145595 A1
(43) Pub. Date: Jun. 13, 2013

(54) TWIN ROLL CONTINUOUS CASTER

(71) Applicants: Gary McQuillis, Blytheville, AR (US); Mark Eastman, Paragould, AR (US); Neal Ross, Blytheville, AR (US)

(72) Inventors: Gary McQuillis, Blytheville, AR (US); Mark Eastman, Paragould, AR (US); Neal Ross, Blytheville, AR (US)

(73) Assignee: NUCOR CORPORATION, Charlotte, NC (US)

(21) Appl. No.: 13/315,964

(22) Filed: Dec. 9, 2011

(51) Int. Cl. B23P 11/00

(52) U.S. Cl. 29/428

(57) ABSTRACT

Method of inhibiting cracking of steel strip in continuous casting of thin strip with the steps of: assembling a pair of counter-rotating casting rolls each with circumferential casting surfaces positioned laterally to form a nip therebetween to cast metal strip downwardly from the nip where each casting roll has lateral coolant passages positioned circumferentially spaced inwardly adjacent the casting surface of the roll, providing a source of coolant to be delivered to a temperature regulator regulating the temperature of the coolant delivered to the coolant passages to between 85° F. and 110° F., assembling a metal delivery system above the casting rolls to deliver molten metal forming a casting pool supported on the casting surfaces of the casting rolls above the nip, and counter-rotating the casting rolls such that the casting surfaces of the casting rolls each travel inwardly toward the nip to produce a cast strip downwardly from the nip.

### BACKGROUND AND SUMMARY

This invention relates to making thin strip and more particularly casting of thin strip by a twin roll caster.

It is known to cast metal strip by continuous casting in a twin roll caster. Molten metal is introduced between a pair of counter-rotating horizontal casting rolls which are cooled so that metal shells solidify on the surfaces of the rotating rolls and are brought together at the nip between the casting rolls to produce a solidified strip product delivered downwardly from the nip. The term “nip” is used herein to refer to the general region at which the rolls are closest together. The molten metal may be poured from a ladle into a smaller vessel or tundish/distributor, from which it flows into and through a molten metal delivery nozzle located above the nip. The delivery nozzle directs the molten metal to form a casting pool supported on the casting surfaces of the rolls above the nip. This casting pool may be confined at the ends of the casting rolls by side plates or dams held in sliding engagement adjacent the ends of the rolls.

The twin roll continuous caster cools the molten metal in the melt pool adjacent the casting surfaces of the casting rolls to form shells on the casting surface. The shells are brought together at the nip to continuously cast metal strip downwardly from the nip. The cooling of the molten metal is achieved by the transfer of heat from the molten metal in the casting pool adjacent the casting surfaces of the casting rolls, into the casting rolls. The casting rolls in turn are cooled by the passage of coolant, typically water, through the interior of the casting rolls. The molten metal in the casting pool is typically at a temperature of approximately 1600° C., the casting rolls are cooled to provide a desired heat flux from the molten metal in contact with the casting surfaces of the casting rolls. It is desirable to have a heat flux which permits the solidification of molten metal on the casting roll surfaces while inhibiting undesired effects, such as cracking, of the steel strip.

In casting thin strip by a twin roll continuous caster, the modification of the crown in the casting surfaces of the casting rolls during a casting campaign is desired. The crown of the casting surfaces of the casting rolls determines the thickness profile, i.e., the cross-sectional shape, of thin cast strip produced by the twin roll caster. The casting rolls are generally formed of copper or copper alloy with internal passages for circulation of coolant, typically water, and usually coated with chromium or nickel to form the casting surfaces. During casting, the casting rolls undergo substantial thermal deformation with exposure to the hot molten metal at the surface of the cooling rolls and the coolant flowing through the interior portions of the casting rolls. The contours of the casting rolls may be altered axially and radially by the heat of the molten metal. Furthermore, the contour of the casting surfaces of the casting rolls change during a casting campaign.

The contour of the casting surfaces effect the surface profile of the cast strip and, therefore, the variation in temperature and the temperature gradient across casting rolls causes complex deformations in the cast strip. The change in the contour of the casting surfaces of the casting rolls, particularly the radial contour, is manifested in the thickness profile and, in turn, the quality of the thin strip that is cast as described in U.S. Publication No. 2010/0032128 A1, published Feb. 11, 2010. Also, the variation of the thickness profile of the thin cast strip may affect downstream operations in the continuous casting operation, such as at the pinch rolls. Alternatively, or in addition, the variation of the thickness profile of the thin cast strip may be the cause of wrinkling and cracking of the strip after rolling.

As described in U.S. Publication No. 2010/0032128 A1, published Feb. 11, 2010, deformation of the crown of the casting surfaces may be controlled by regulating the temperature of the cooling water flowing through the coolant passages of the casting rolls. In turn, the thickness profile of the cast strip can be controlled with the control of the crown of the casting surfaces of the casting rolls. To control the temperature of the cooling water, to achieve a desired strip thickness profile, a thickness profile sensor, for example, may be positioned downstream from the nip to detect the thickness profile of the cast trip. Such a sensor may be an x-ray gauge or other suitable device capable of directly measuring the thickness profile across the width of the cast strip, either periodically or continuously. The output from such sensors may be used to control a coolant temperature regulator to regulate the temperature of the coolant delivered to the coolant passages, and in turn control the surface contour of the casting rolls.

Also, as described in US Publication No. 2010/0032128 A1, twin roll casters may have casting rolls in the form of cylindrical bodies typically including a main roll shaft that could be made to be watertight, and have pressurized tubes connected through the main roll shaft to the interior of the circumferential portion of the casting roll body. The circumferential portion of the cylindrical body is typically a watertight copper sleeve with internal coolant passages in thermal engagement with the outer circumference of the circumferential portion, being the casting surface, and pre-shaped to impart a concavely shaped reverse crown to the central portion of the casting roll to make possible the hydrostatic expansion and contraction of the circumferential body portion varying the contour of the casting roll through liquid pressure. The variations in the coating surfaces of the casting rolls during casting may cause cracks on the surface of the steel strip being cast.

Disclosed is a method of inhibiting cracking of steel strip in a continuous casting of thin strip comprising the steps of: assembling a pair of counter-rotating casting rolls, each with circumferential casting surfaces positioned laterally to form a nip therebetween to cast metal strip downwardly from the nip where each casting roll has lateral coolant passages positioned circumferentially spaced inwardly adjacent the casting surface of the roll, providing a source of coolant to be delivered to a temperature regulator, providing a coolant temperature regulator to regulate the temperature of the coolant delivered to the coolant passages to a temperature of between 85° F. and 110° F., delivering coolant through the regulator to the coolant passages at a temperature between 85° F. and 110° F., assembling a metal delivery system above the casting rolls to deliver molten metal forming a casting pool supported on the casting surfaces of the casting rolls above the nip, and counter-rotating the casting rolls such that the casting surfaces of the casting rolls each travel inwardly toward the nip to produce a cast strip downwardly from the nip inhibiting cracking of steel strip in continuous casting of thin strip. In some embodiments, the method may comprise the steps of providing a coolant temperature regulator to regulate the temperature of the coolant delivered to the coolant passages, the temperature for the coolant delivered to the coolant passages being regulated to between 85° F. and 150° F., and delivering of the coolant through the temperature regulator to the cooling passages at a temperature between 85° F. and 150° F. In other embodiments, the temperature regulator may regulate the temperature of the coolant delivered to the coolant passages to a temperature not less than 90° F.

As the coolant flows through the interior portions of the casting rolls, it heats as the heat from the molten metal is transferred through the casting rolls to the coolant. This creates the potential for the temperature of the coolant at one end of the casting rolls to be different to that at the other end of the casting rolls, causing the casting rolls to longitudinally deform. Longitudinal deformation of the casting rolls may deform the cast strip, producing a cast strip having a different profile on one side than the other, and/or cast strip with surface cracks. To avoid such deformation of the cast strip, the coolant may flow in opposite directions through each alternate coolant passage.

The coolant temperature regulator may be a cooling water tower, in the case where the coolant is water. The coolant temperature regulator may be connected to one or more sensors to measure the temperature of the coolant at different stages through a coolant circuit. The temperature regulator being adapted to regulate the temperature of the coolant in response to the measurements of one or more of the sensors.

Various aspects of the invention will be apparent from the following detailed description, drawings and claims.

### BRIEF DESCRIPTION OF THE DRAWINGS

FIG. 1 is a side elevational view of a portion of a continuous twin roll caster system;

FIG. 2 is a partial sectional view through the twin roll caster system shown in FIG. 1;

FIG. 3 is a sectional view through the casting rolls of the caster system shown in FIG. 1;

FIG. 4 shows a graph illustrating the incidence of cracking on the surface of steel strip relative to the coolant temperature delivered to the casting rolls, or mold.

FIG. 5 shows two graphs illustrating the incidence of cracking on the surface of steel strip relative to the coolant temperature delivered to the casting rolls, or mold.

### DETAILED DESCRIPTION OF THE DRAWINGS

Presently disclosed are methods for inhibiting cracking of steel strip in a continuous casting of thin strip. Such methods may comprise the steps of assembling a pair of counter-rotating casting rolls, each with circumferential casting surfaces positioned laterally to form a nip therebetween to cast metal strip downwardly from the nip where each casting roll has lateral coolant passages positioned circumferentially spaced inwardly adjacent the casting surface of the roll. The methods may also include the step of providing a source of coolant to be delivered to a temperature regulator, providing a coolant temperature regulator to regulate the temperature of the coolant delivered to the coolant passages at a temperature between 85° F. and 110° F.; and delivering of the coolant to the coolant passages at a temperature between 85° F. and 110° F. In some embodiments, the method may include the steps of: providing a coolant temperature regulator to regulate the temperature of the coolant delivered to the coolant passages, the temperature for the coolant delivered to the coolant passages being regulated to between 85° F. and 150° F.; delivering of the coolant to the coolant passages at a temperature between 85° F. and not more than 150° F. In other embodiments, the temperature regulator may regulate the temperature of the coolant delivered to the coolant passages to a temperature of not less than 90° F.

Such methods may further comprise the steps of assembling a metal delivery system above the casting rolls to deliver molten metal forming a casting pool supported on the casting surfaces of the casting rolls above the nip, and counter-rotating the casting rolls such that the casting surfaces of the casting rolls each travel inwardly toward the nip to produce a cast strip downwardly from the nip inhibiting cracking of steel strip in continuous casting of thin strip.

In typical embodiments, the coolant may be water. Coolant may be provided to the coolant passages in the casting rolls from a number of different sources. Examples of such sources may include a water cooling tower, whereby the coolant circulates through a coolant circuit comprising the coolant passages in the casting rolls as well as a cooling tower for cooling the coolant to a desired temperature. Using a cooling tower allows for repeated use of the same coolant medium. The temperature of the coolant delivered to the casting rolls may be varied by the coolant temperature regulator. The continuous caster may comprise of strip surface monitoring sensors. Such sensors may monitor the temperature of the strip surface, the amount and severity of surface cracking, the strip profile or other properties of the cast strip. The sensors may output signals relating to the measured properties of the strip surface. The controller and/or temperature regulator may control the temperature of the coolant in response to the outputs from the cast strip surface monitoring sensors to achieve desired cast strip properties. The molten metal delivered to the continuous caster may have varied compositions. One such composition may comprise not less than 0.005% by weight and not more than 0.5% by weight of carbon, not less than 0.3% by weight and not more than 1.6% by weight of manganese, not less than 0.1% by weight and not more than 0.3% by weight of silicon, not less than 0.001% and not more than 0.05% by weight of niobium, and not less than 0.001% by weight and not more than 0.001% by weight of sulfur. In some embodiments, the molten steel comprises more than 0.8% by weight of manganese. In other embodiments, the molten steel comprises more than 0.5% by weight of manganese.

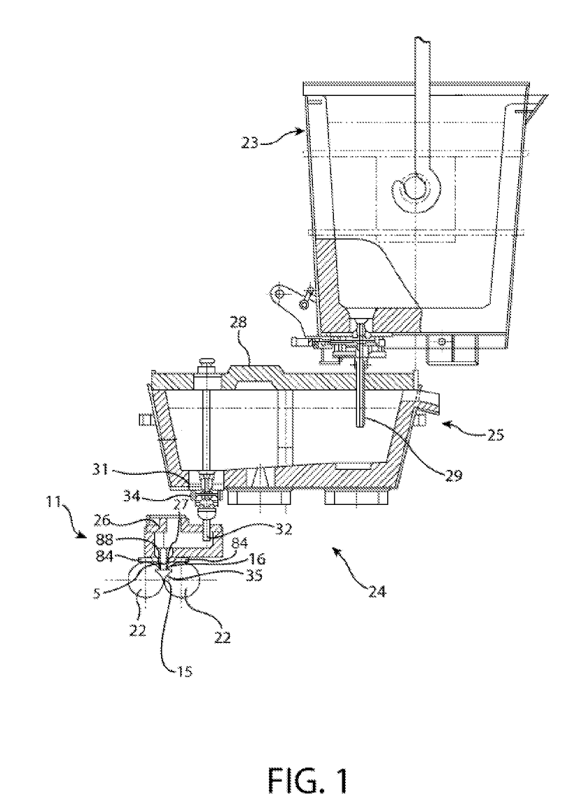

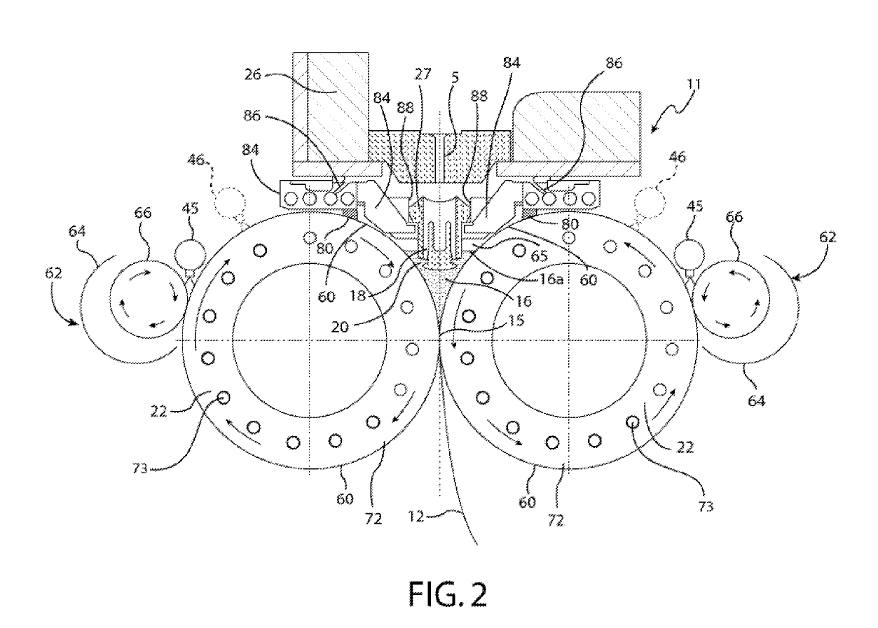

Referring now to FIGS. 1 and 2, a twin roll caster 11 comprises a pair of laterally positioned casting rolls 22 forming a nip 15 between circumferential casting surfaces 60 of the rolls 22, for which molten metal is delivered from a ladle 23 through a metal delivery system 24 to the caster. The metal delivery system 24 comprises a tundish 25, a movable tundish 26 and one or more core nozzles 27 positioned between the casting rolls 22 above the nip 15. The molten metal delivered to the casting rolls is supported in a casting pool 16 on the casting surfaces 60 of the casting rolls 22 above the nip 15. The casting pool 16 of molten metal supported on the casting rolls 22 is confined at the ends of the casting rolls 22 by a pair of side dams 35.

The tundish 25 is fitted with a lid 28. Molten steel is introduced into the tundish 25 from a ladle 23 via an shroud 29. The tundish 25 is fitted with a slide gate 34 to selectively open and close the outlet 31 and effectively control the flow of molten metal from the tundish 25 to the distributor 26 (also called the removable tundish or transition piece). In operation, the molten metal flows from tundish 25 through outlet 31, through inlet 32 of the distributor 26, through passageways 5, and then to delivery nozzles or core nozzles 27. The core nozzles 27 are supported in the casting position by a core nozzle support plate 84. The core nozzle support plate 84 is positioned beneath the distributor 26 and has a central opening 88 to receive the delivery nozzle 27. The delivery nozzle 27 may be provided in two or more segments, and at least a portion of each core nozzle segment may be supported by the core nozzle plate 84.

Several passages 5 may be provided along the length of the delivery nozzle 27 to provide for a more even flow of molten metal into the delivery nozzle 27. The molten metal may flow through the delivery nozzle 27 to the outlets 20 through passages 18. The outlets 20 direct flow of molten metal discharging the molten metal into a casting pool 16 supported on the surface of the casting rolls 22 above the nip 15. The upper surface 16a of casting pool 16 will generally rise above the lower end of the delivery nozzle 27 so that the lower end of the delivery nozzle 27 is submerged within the casting pool 16.

The casting rolls 22 may typically be about 500 millimeters in diameter, and may be up to 1200 millimeters or more in diameter. The length of the casting rolls 22 may be up to about 2000 millimeters, or longer, in order to enable production of strip product of about 2000 millimeters in width, or wider, as desired in order to produce strip product approximately the width of the rolls. The casting surfaces 60 may be textured, for example, with a random distribution of discrete projections as described and claimed in U.S. Pat. No. 7,073,365.

Referring to FIG. 2, assembled in the pair of counter-rotated casting rolls 22, each with circumferential casting surfaces 60, and lateral coolant passages 73 positioned circumferentially spaced inwardly adjacent the casting surface 60 of the casting rolls 22. The coolant passages 73 conveying coolant to cool the casting rolls 22, removing heat from the molten metal in the casting pool 16 adjacent the casting surfaces 60, so that shells of metal solidify on the casting surfaces 60 as the casting surfaces move in contact with the casting pool 16. The casting rolls 22 may comprise at least one outer circumferential portion 70, each circumferential portion 70 typically comprised of a sleeve 72 of copper or copper alloy, the outer surface of the outer circumferential portion 70 (usually coated with, for example, chromium alloy) forms the casting surface 60 of the casting rolls 22. A plurality of cooling passages 73 may be provided in each circumferential portion 70 adjacent the casting surface 60 of the casting rolls 22, spaced inwardly in the sleeve 72. The coolant passages 73 may be alternately arranged in the sleeve 72 so that the coolant in adjacent coolant passages 73 flows in opposite directions to provide for more responsive temperature distribution along the length of the casting roll 22, inhibiting longitudinal thermal deformation of the casting roll 22.

In the present method of inhibiting cracking of steel strip 12 in continuous casting of strip 12, there may be provided a source of coolant to be delivered to a temperature regulator 90, providing a coolant temperature regulator 90 to regulate the temperature of the coolant delivered to the coolant passages 73 at a temperature between 85° F. and 110° F., and delivering of the coolant through the regulator 90 to the coolant passages 73 at a temperature between 85° F. and 110° F. In some embodiments, the present method may comprise the steps of providing a coolant temperature regulator 90 to regulate the temperature of the coolant delivered to the coolant passages 73 at a temperature between 85° F. and 150° F., and delivering of the coolant through the regulator 90 to the coolant passages 73 at a temperature between 85° F. and 150° F. In other embodiments, a coolant temperature regulator may be provided to regulate the temperature of the coolant delivered to the coolant passages 73, the temperature for the coolant delivered to the coolant passages 73 being regulated to not less than 90° F.

During operation, as the casting rolls 22 are counter-rotated, heat in the molten metal in the casting pool 16 is transferred to the casting rolls 22 allowing the molten metal to solidify as shells on the casting surfaces 60 of the casting rolls 22. The shells are brought together at the nip 15 to produce a solidified thin cast product 12 cast downwardly from the nip 15. The heat from the molten metal adjacent the casting rolls 22 is transferred into the outer circumferential portion 70 of the casting rolls 22 and, in-turn, into the coolant flowing along the coolant circuit 75, through regulator 90, and the coolant passages 73, the regulator 90 connected to the coolant passages 73 through coolant circuit 75. The coolant continually transferring heat away from the casting rolls 22 allowing shells to solidify on the casting surfaces 60. The coolant also protects the casting rolls 22 by cooling the casting rolls, preventing the casting rolls from becoming over-heated and permanently deformed.

During a casting campaign, the casting surfaces 60 of the casting rolls 22 may be in contact with molten metal having a temperature in excess of 1600° C. The casting surfaces 60 may be typically kept at a temperature of approximately 400° C. The temperature of the casting surfaces 60 correlates to the temperature of the coolant supplied to the coolant passages 73. The lower the temperature of the coolant in the coolant passages 73, the lower the temperature of the casting surfaces 60 of the casting rolls 22. A lower temperature of the casting surfaces 60 allows for a greater heat flux between the molten metal in the casting pool 16 and the surface 60 of the casting rolls 22, cooling the molten metal more rapidly, allowing for increased casting speed. However, through testing, it has been discovered that when the coolant being delivered to the coolant passages 73 is too low, thereby providing a relatively cool casting surface 60, cracks form on the surface of the cast strip 12. The increased heat flux between the molten metal in the casting pool 16 and the casting surfaces 60 of the casting rolls 22 allows the molten metal adjacent the casting rolls 22 to cool more rapidly.

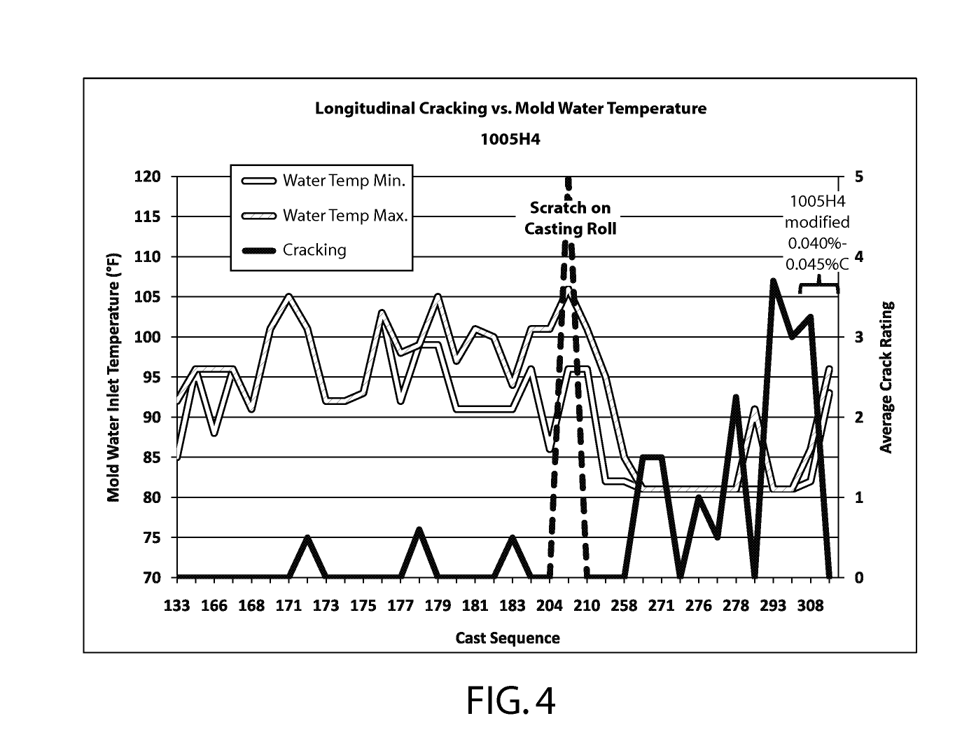

As illustrated by the graphs in FIG. 4, it has been found that a coolant, being delivered to the coolant passages 73, in the casting rolls 22, having a minimum temperature of below 85° F. will produce a thin cast strip 12 with increased surface cracks. The graph in FIG. 4 shows relatively little surface cracking of the cast strip 12 when the minimum temperature of the coolant being delivered to the coolant passages 73, in the casting rolls 22, was maintained above about 90° F. Conversely, when the minimum temperature of the coolant being delivered to the coolant passages 73 was decreased below 85° F., there was a significant increase in the amount of cracking on the surface of the cast strip 12. Therefore, regulator 90 maintains a coolant temperature greater than 85° F. being delivered to the coolant passages 73 of the casting rolls 22.

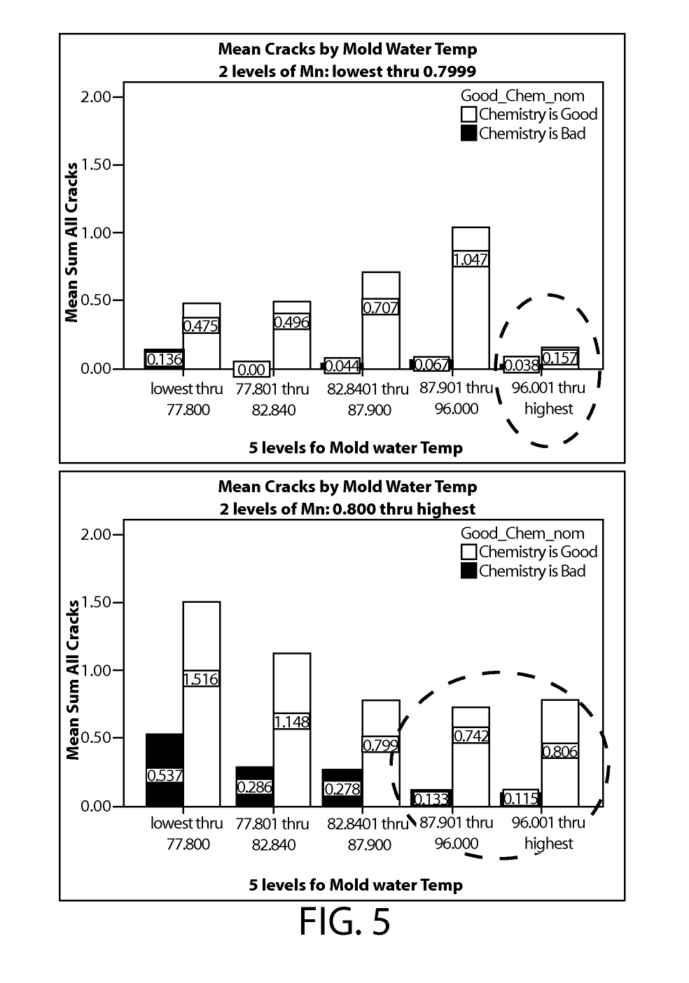

FIG. 5 shows two graphs showing results of tests measuring the cracks on the surface of the cast strip 12 corresponding to the coolant delivered to the coolant passages 73 in the casting rolls 22. The first graph shows test results for a metal composition having less than 0.8% by weight of manganese. Specifically, the second graph shows that when the coolant water being delivered to the coolant passages 73 had a temperature of greater than 96.0° F., the incidence of surface cracks on the cast strip 12 was at its lowest level, for a molten metal comprised of less than 0.8% by weight of manganese. The second graph shows results for a molten metal comprising not less than 0.8% by weight of manganese. Specifically, the graph shows that when the coolant water being delivered to the coolant passages 73 had a temperature of greater than 87.9° F. the incidence of surface cracks on the cast strip 12 was at its lowest level, for a molten metal comprised of not less than 0.8% by weight of manganese. The results of these tests indicates that high strength strip, i.e. strip with a higher manganese content, are more sensitive to the coolant temperature being delivered to the coolant passages 73, than strip having a lower manganese content. Furthermore, the tests reveal that a coolant temperature delivered to the coolant passages 73 cannot be less than about 85° F. In operation, below the nip 15, the thin cast strip 12 is passed into a sealed enclosure (not shown) and onto a guide table (not shown), which guides the strip 12 to a pinch roll stand (not shown) through which it exits the sealed enclosure. The enclosure may not be completely sealed, but appropriately sealed to allow control of the atmosphere within the enclosure so as to restrict ingress of oxygen within the enclosure. After exiting the sealed enclosure, the strip 12 may pass through additional sealed enclosures and pinch rolls to provide tension on the strip 12 during in-line hot rolling and cooling treatment before coiling.

As shown in FIG. 2, a pair of roll brush apparatus 62 are disposed adjacent the pair of casting rolls 22 such that they may be brought into contact with the casting surfaces 60 of the casting rolls 22 at opposite sides of nip 15 prior to the casting surfaces 60 of the casting rolls 22 coming into contact with the molten metal in casting pool 16. Each brush apparatus 62 may comprise a brush frame 64 which carries a main cleaning brush 66 for cleaning the casting surfaces 60 of the casting rolls 22 during the casting campaign as described in U.S. Pat. No. 7,299,857. Optionally in addition, separate sweeper brushes (not shown) for cleaning the casting surfaces of the casting rolls at the beginning and end of the campaign may also be provided as shown in U.S. Pat. No. 7,938,164.

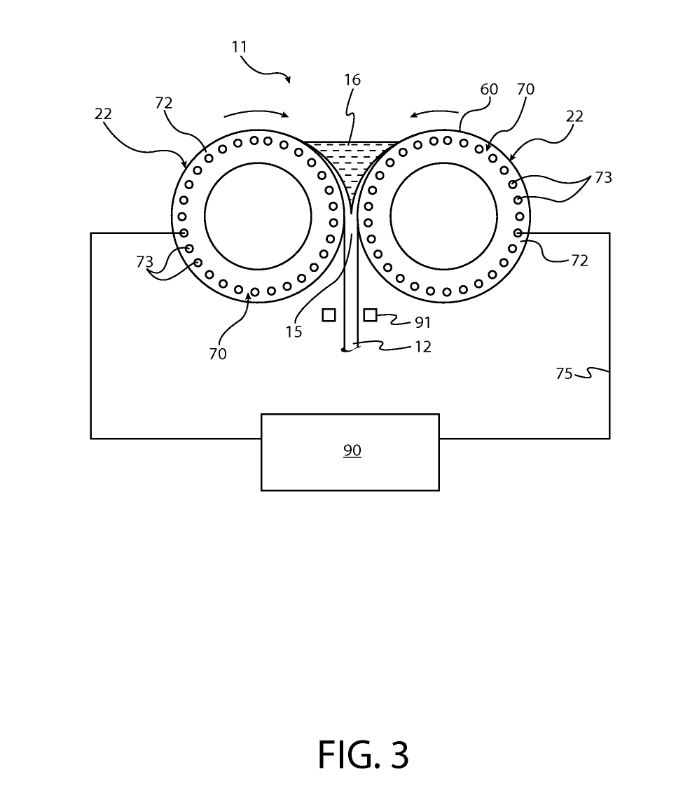

Referring to FIG. 3, an enclosure 65 forming a casting area above the casting pool 16 is bounded by the casting surfaces 60 of the casting rolls 22 above the nip 15 and the side dams 35. The enclosure 65 may include a pair of carbon seals 80, one positioned between the core nozzle support plate 84 and each casting roll 22 restricting ingress of ambient air into the casting area. A gas mixture may be delivered into the enclosure 65 forming a protective gas layer over the casting pool 16 between the casting surfaces 60 of the casting rolls 22. The enclosure 65 may be sealed or semi-sealed, restricting outside atmosphere gases from entering the enclosure 65. The gas mixture may be introduced to the enclosure 65 over the casting pool 16 via core nozzle plates 84. As described in U.S. Pat. No. 7,938,164, the side dams 35 (shown in FIG. 1) may be positioned on a core nozzle support plate 84 mounted on a roll cassette so as to extend horizontally above, and adjacent the ends of, the casting rolls 22. The core-nozzle plate 84 has a central opening 88 to support metal delivery nozzle 27. The core-nozzle plates 84 may comprise gas delivery ports 86 located on each side of the casting apparatus 11 such as to deliver a gas mixture into the enclosure 65 above the casting pool 16. The gas mixture may be delivered upwardly into the enclosure 65 such as to avoid disturbing the surface 16a of the casting pool 16, which may cause surface defects in the form of meniscus marks on the surface of the formed thin strip 12. In the alternative, the gas mixture may be delivered from substantially near the edges of the casting pool 16 where surface 16a of the casting pool 16 meets the casting surface 60 of casting rolls 22, or directed downwardly toward the surface 60 of the casting rolls 22. In addition, the gas mixture may be delivered from a gas header 45. The gas header 45 may be positioned to deliver gas to the casting surfaces 60 of the casting rolls 22, at any position between the main cleaning brushes 66 and the 12 ‘o’ clock position above the casting rolls 22 as part of the texture gases, such as at the position indicated by gas header 46.

It is to be understood that the above described embodiments and other embodiments may be made and performed within the scope of the following claims. While the principle and mode of operation of this invention have been explained and illustrated with regard to particular embodiments, it must be understood, however, that this invention may be practiced otherwise than as specifically explained and illustrated without departing from its spirit or scope.

1. Method of inhibiting cracking of steel strip in continuous casting of thin strip comprising the steps of:
assembling a pair of counter-rotating casting rolls each with circumferential casting surfaces positioned laterally to form a nip therebetween to cast metal strip downwardly from the nip where each casting roll has lateral coolant passages positioned circumferentially spaced inwardly adjacent the casting surface of the roll,
providing a source of coolant to be delivered to a temperature regulator,
providing a coolant temperature regulator to regulate the temperature of the coolant delivered to the coolant passages, the temperature for the coolant delivered to the coolant passages being regulated to between 85° F. and 110° F.,
delivering of the coolant through the regulator to the coolant passages at a temperature between 85° F. and 110° F.,
assembling a metal delivery system above the casting rolls to deliver molten metal forming a casting pool supported on the casting surfaces of the casting rolls above the nip, and
counter-rotating the casting rolls such that the casting surfaces of the casting rolls each travel inwardly toward the nip to produce a cast strip downwardly from the nip inhibiting cracking of steel strip in continuous casting of thin strip.

2. The method of inhibiting cracking of steel strip in continuous casting of thin strip as claimed in claim 1 where the temperature regulator regulates the temperature of the coolant delivered to the coolant passages to a temperature of not less than 90° F.

3. The method of inhibiting cracking of steel strip in continuous casting of thin strip as claimed in claim 1 where the coolant is water.

4. The method of inhibiting cracking of steel strip in continuous casting of thin strip as claimed in claim 1 where the temperature of the coolant delivered to the casting rolls is varied by the coolant temperature regulator.

5. The method of inhibiting cracking of steel strip in continuous casting of thin strip as claimed in claim 4 where the coolant temperature regulator varies the temperature of the coolant in response to outputs from cast strip surface monitoring sensors.

6. The method of inhibiting cracking of steel strip in continuous casting of thin strip as claimed in claim 1 where the coolant temperature regulator comprises a cooling water tower.

7. The method of inhibiting cracking of steel strip in continuous casting of thin strip as claimed in claim 1 where molten metal comprises:
not less than 0.005 and not more than 0.5% by weight of carbon,
not less than 0.3 and not more than 1.6% by weight of manganese,
not less than 0.1 and not more than 0.3% by weight of silicon,
not less than 0.001 and not more than 0.05% by weight of niobium,
not less than 0.001 and not more than 0.003% by weight of sulfur.

8. The method of inhibiting cracking of steel strip in continuous casting of thin strip as claimed in claim 1 wherein the molten metal comprises not less than 0.8% by weight of manganese.

9. The method of inhibiting cracking of steel strip in continuous casting of thin strip as claimed in claim 1 wherein the molten metal comprises not less than 0.5% by weight of manganese.
